(19) United States
(12) Patent Application Publication
(10) Pub. No.: US 2024/0123331 A1
(43) Pub. Date: Apr. 18, 2024

(54) METHOD AND ELECTRONIC DEVICE FOR PROCESSING GAME SIGNAL

(71) Applicant: NETEASE (HANGZHOU) NETWORK CO., LTD., Hangzhou, Zhejiang (CN)

(72) Inventors: Jiajun FAN, Hangzhou, Zhejiang (CN); Zhaoda HE, Hangzhou, Zhejiang (CN)

(73) Assignee: NETEASE (HANGZHOU) NETWORK CO., LTD., Hangzhou, Zhejiang (CN)

(21) Appl. No.: 18/264,431

(22) PCT Filed: Aug. 9, 2021
(86) PCT No.: PCT/CN2021/111539

§ 371 Date: Aug. 7, 2023

(30) Foreign Application Priority Data
Feb. 8, 2021 (CN) 202110172779.5

(51) Int. Cl. A63F 13/2145; A63F 13/5372; A63F 13/5378

(52) U.S. Cl. CPC A63F 13/2145; A63F 13/5372; A63F 13/5378

(57) ABSTRACT

A method and an electronic device for processing a game signal are provided, the method includes: providing a first operation region in response to an interaction operation acting on a graphical user interface, determining a target signal identifier from the at least one signal identifier in response to a first touch operation acting on the first operation region; providing a second operation region and at least one first game object identifier through the graphical user interface; determining a target game object identifier from the at least one first game object identifier in response to a second touch operation acting on the second operation region; sending a target signal for the target game object identifier according to the target signal identifier in response to an end of the second touch operation.

### CROSS-REFERENCE

This application claims a priority to and benefits of Chinese Patent Application No. 202110172779.5, entitled “GAME SIGNAL PROCESSING METHOD AND APPARATUS”, filed on Feb. 8, 2021, the entire content of which are incorporated herein by reference.

### TECHNICAL FIELD

The present disclosure relates to a field of interactive technology, and more particularly, to a method for processing the game signal and an apparatus for processing a game signal.

### BACKGROUND

There are many types of games in the game industry, including card games, role-playing games, and multiplayer online tactical competitive games, in which in a Multiplayer Online Battle Arena Games (MOBA), a player needs to communicate with his/her teammate as necessary depending on battle situation, and the most convenient manner to communicate is in a manner of sending a signal.

It should be noted that information disclosed above is merely configured to enhance understanding of BACKGROUND of the present disclosure, which may include information that does not constitute a prior art known to those skilled in the related art.

### SUMMARY

Embodiments of the present disclosure provide a method for processing the game signal and a corresponding apparatus for processing the game signal, in order to provide a means of overcoming the above problems or at least partially solving the above problems.

In a first aspect, embodiments of the present disclosure discloses a method for processing a game signal, where a graphical user interface is provided through a terminal, the method includes: providing, in response to an interaction operation acting on the graphical user interface, a first operation region, where the first operation region includes at least one signal identifier; determining, in response to a first touch operation acting on the first operation region, a target signal identifier from the at least one signal identifier; providing a second operation region and at least one first game object identifier through the graphical user interface; determining, in response to a second touch operation acting on the second operation region, a target game object identifier from the at least one first game object identifier; sending, in response to an end of the second touch operation, a target signal for the target game object identifier according to the target signal identifier.

In a second aspect, embodiments of the present disclosure further discloses an apparatus for processing a game signal, where a graphical user interface is provided through a terminal, and the apparatus includes: a first operation region supply module, configured to provide, in response to an interaction operation acting on the graphical user interface, a first operation region, where the first operation region includes at least one signal identifier; a target signal identifier determination module, configured to determine, in response to a first touch operation acting on the first operation region, a target signal identifier from the at least one signal identifier; a second operation region supply module, configured to provide a second operation region and at least one first game object identifier through the graphical user interface; a target game object identifier determination module, configured to determine, in response to a second touch operation acting on the second operation region, a target game object identifier from the at least one first game object identifier; a target signal sending module, configured to send, in response to an end of the second touch operation, a target signal for the target game object identifier according to the target signal identifier.

In a third aspect, embodiments of the present disclosure further discloses an electronic device, including a processor, a memory and a computer program stored on the memory and capable of running on the processor, when the computer program is executed by the processor, the method according to the first aspect is implemented.

In a fourth aspect, embodiments of the present disclosure further discloses a computer-readable storage medium with a computer program stored thereon, when the computer program is executed by a processor, the method according to the first aspect is implemented.

It should be understood that the above general description and the following detailed description are only exemplary and explanatory and should not limit the present disclosure.

### BRIEF DESCRIPTION OF THE DRAWINGS

FIG. 1 is a schematic diagram of a signal sending method in an existing game;

FIG. 2 is a schematic diagram of another signal sending method in the existing game;

FIG. 3 is a step flowchart of a method for processing a game signal according to an embodiment of the present disclosure;

FIG. 4 is a schematic diagram of a display region and an operation region according to an embodiment of the present disclosure;

FIG. 5 is a step flowchart of another method for processing a game signal according to an embodiment of the present disclosure;

FIG. 6 is a schematic diagram of switching a first operation region to a second operation region according to an embodiment of the present disclosure;

FIG. 7 is a specific schematic diagram of an operation region under different states according to an embodiment of the present disclosure;

FIG. 8 is a schematic diagram of switching of inner and outer-ring states according to an embodiment of the present disclosure;

FIG. 9 is an application scenario diagram of a method for processing a game signal according to an embodiment of the present disclosure;

FIG. 10 is a schematic diagram for determining a distance between a game object and a virtual character according to an embodiment of the present disclosure;

FIG. 11 is a schematic diagram of divided quadrant regions according to an embodiment of the present disclosure;

FIG. 12 is a schematic diagram of another divided quadrant regions according to an embodiment of the present disclosure;

FIG. 13 is a structural block diagram of an apparatus for processing a game signal according to an embodiment of the present disclosure.

### DETAILED DESCRIPTION

To make the above objects, features and advantages of the present disclosure more obvious and easier to understand, the present disclosure is further described in detail below with reference to the accompanying drawings and specific embodiments.

In games such as MOBA, FPS (First-Person Shooter Game), RPG (Role-playing game), and the like, communication with teammates may often be done by sending a signal.

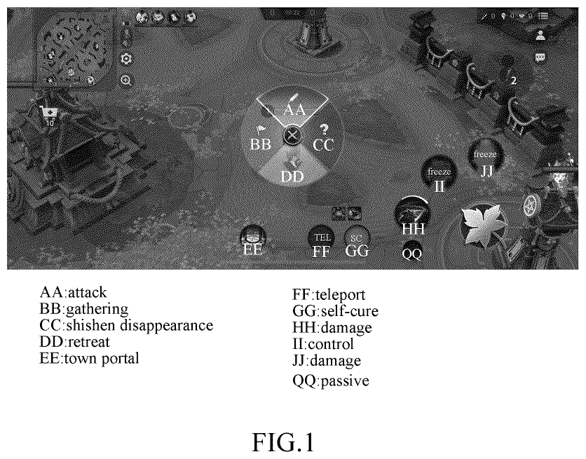

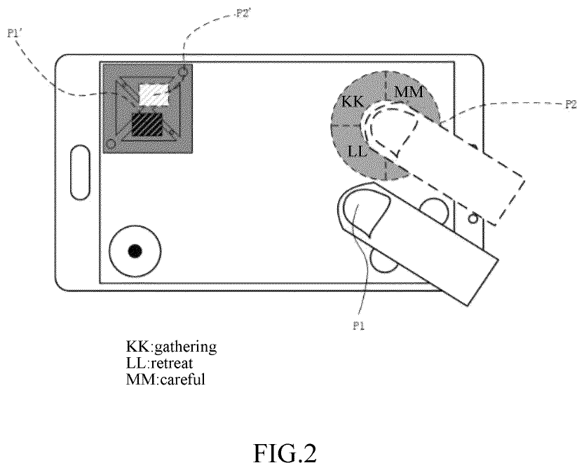

Specifically, referring to FIG. 1-2, schematic diagrams of specific examples of signal sending method in an existing game are shown. As shown in FIG. 1, the signal sending method of an object is selected by a roulette wheel, and a signal roulette wheel may be called out by pressing the signal. A selection of different categories of signals, such as “attack”, “enemy disappearance”, “retreat”, “gathering” and the like, may be provided on a called-out signal roulette wheel, and a player may quickly drag and select the signal and send the corresponding signal.

As shown in FIG. 2, the signal sending method of the object is selected by dragging a pop-up mini map, and the mini map may be called out by pressing a corresponding icon. The player may select a prompt object region in the mini map by a sliding operation. As shown in FIG. 2, when a player touch point is slid from a P1 position to a P2 position, a corresponding position in the mini map is updated from a P1′ region to a P2′ region. In this process, if the re-press or long-press operation is detected, the signal roulette wheel is called out. Taking selecting an appropriate type of a target signal through the signal roulette wheel as an example, an enemy position in the mini map is selected by the sliding operation in the drawings, the player selects the target signal through the signal roulette wheel and then releases it, so as to send a target signal of the enemy position, such as attack xxx.

However, the applicant found the following defects in the above related art during the long-term game research:

(1) For the signal sending method shown in FIG. 1 above, the signal sent is merely directed to different categories of signals and is not directional, and that is, teammates cannot perceive where to gather, who to attack, where to disappear and who needs to retreat.

(2) For the signal sending method shown in FIG. 2, although the signal may have a certain directivity, it is not convenient for the player to search for the object in the map after calling out the mini map, and when there are a plurality of objects in close positions on the mini map, it is impossible to accurately determine the object to be selected on the mini map through the sliding operation, which is easy to cause a problem of accidental touch. In addition, the signal sending method shown in FIG. 2 is to determine a prompt object by the sliding operation, and then call out the signal roulette wheel by the re-press or long-press operation during the sliding process. Since different players have different touch strength when sliding the screen, for the player with a relatively touch strength when sliding, it is easy to make an error when sliding to select the prompt object, resulting in continuous call out of the signal roulette wheel, and causing relatively poor game experience.

Based on above-mentioned shortcomings of the common signal sending methods in the existing game, one of core concepts of embodiments of the present disclosure is to propose a signal sending method with corresponding operation regions under different states, which may allow the player to quickly select different signal types and specific game objects, such that the player may quickly and accurately select a game object that are specifically directed and send the signal. The player may also be informed of a real-time position prompt of the game object that is directed and a prompt of a nearby game object. Moreover, a sending method with a double-ring form for an operation region and a display region is proposed, and a data link of an operation-view corresponding relationship between the operation region and the display region is performed, so as to achieve a real-time change and prompt of the operation region and the display region under different states, and improve the operation experience and efficiency.

A method for processing a game signal in an embodiment of the present disclosure may be run on a terminal device or a server. The terminal device may be a local terminal device. When the method for processing the game signal is run on the server, the method for processing the game signal may be implemented and executed based on a cloud interaction system, and the cloud interaction system includes a server and a client device.

In an optional embodiment, various cloud applications, such as cloud games, may be run under the cloud interaction system. Taking cloud games as an example, a cloud game refers to a game method based on cloud computing. In the running mode of the cloud games, a running body of a game program and a presentation body of a game screen are separated. The storage and operation of the method for processing the game signal are completed on the cloud game server. The client device is used for data receiving and sending, and presentation of the game screen. For example, the client device may be a display device with a data transmission function close to a user side, such as a mobile terminal, a TV, a computer, a handheld computer, and the like. The terminal device of the method for processing the game signal is a cloud game server in the cloud. When playing the game, the player operates the client device to send operation instructions to the cloud game server, and the cloud game server runs the game according to the operation instructions, encodes and compresses the game screen and other data, returns it to the client device through the network, and finally decodes and outputs the game screen through the client device.

In an optional embodiment, the terminal device may be a local terminal device. Taking a game as an example, the local terminal device stores a game program and is used to present a game screen. The local terminal device is used to interact with the player through a graphical user interface, that is, the game program is downloaded, installed and executed through an electronic device conventionally. The graphical user interface may be provided to the player by the local terminal device in various ways. For example, the graphical user interface may be rendered and displayed on the display screen of the terminal, or may be provided to the player through holographic projection. For example, the local terminal device may include a display screen and a processor. The display screen is used for presenting a graphical user interface including a game screen, and the processor is used for running the game, generating the graphical user interface, and controlling display of the graphical user interface on the display.

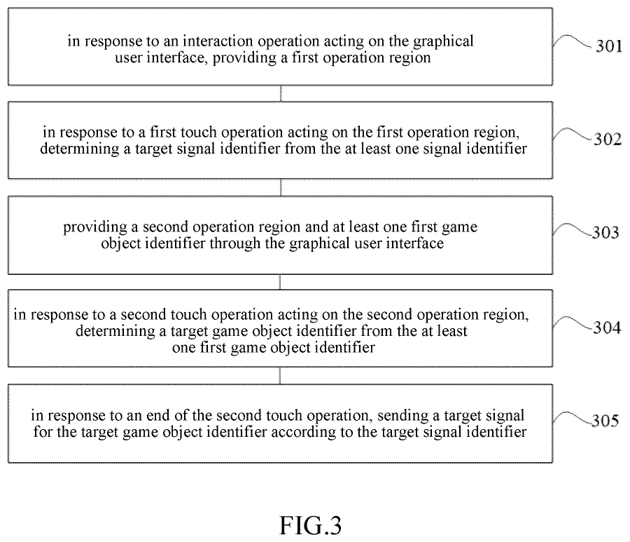

Referring to FIG. 3, a step flowchart of a method for processing a game signal according to an embodiment of the present disclosure is shown. A graphical user interface is provided through a terminal, which may specifically include the following steps:

in step 301: in response to an interaction operation acting on the graphical user interface, a first operation region is provided, where the first operation region includes at least one signal identifier;

It should be noted that the mobile terminal may be the local terminal device mentioned above, or may be a client device in the cloud interaction system mentioned above. An operation system of the mobile terminal may include Android, IOS, Windows Phone, Windows, and the like, and may typically support the running of various game applications.

By running a game application on the mobile terminal, and the graphical user interface is obtained on a display of the mobile terminal by rendering, content displayed in the graphical user interface contains at least a part or all of the game scene. The specific shape of the game scene may be square or other shapes (such as circle, and the like).

In an embodiment of the present disclosure, in response to the interaction operation acting on the graphical user interface including the game scene. The specific graphical user interface may include at least one signal icon, and the player may perform interaction operation on the signal icon to call out a preset interface for controlling generation and transmission of the signal. The preset interface may be presented in a form of a translucent covered game scene. The specific shape of the called-out preset interface may be square or other shapes (such as circle, and the like), which is not limited in the embodiments of the present disclosure.

The called-out preset interface may be provided with the first operation region for operation. The first operation region may include at least one signal identifier corresponding to different signal types. The signal type may provide a gathering type, an attack type, a defense type, and the like, such that the player may touch and select the signal identifier to determine the different signal types to be sent.

in step 302: in response to a first touch operation acting on the first operation region, a target signal identifier is determined from the at least one signal identifier;

Further, after detecting the first touch operation of the player acting on the first operation region, a selected current signal type is determined, that is, the target signal identifier is determined from the at least one signal identifier, such that the game object provided for selection at the subsequent selection of the target game object is a game object belonging to the currently selected signal type.

In the embodiment of the present disclosure, in the process of providing the player with a quick selection of the signal type to be sent (i.e. the target signal identifier), the player may first be provided with a preset interface for selection, and the preset interface is provided with the first operation region to allow the player to perform the selection. Since the selection manner is not performed by first determining the prompt object and then selecting the prompt object (which may refer to a different signal identifier here), a touch error caused by the sliding touch strength of the player may not occur.

in step 303: a second operation region and at least one first game object identifier are provided through the graphical user interface;

In practical applications, in order to provide the user with the game object belonging to the currently selected signal type for selection, after detecting the first touch operation acting on the first operation region, a second operation region for selecting the target game object may be provided, where the provided second operation region may include at least one game object identifier. It should be noted that the game object identifier may be an avatar identifier of the game object, also may be a digital identifier, a text identifier, and the like, which is not limited in the embodiments of the present disclosure.

In a preferred embodiment, when the first touch operation on the first operation region is detected, that is, after the target signal identifier is determined, the second operation region may be provided, which may be expressed as switching the operation region, i.e., switching the first operation region to the second operation region.

The switching of the operation region may essentially be a switching of the state of the operation region provided on the preset interface, where the operation region with a state before the switching may be expressed as the first operation region, and the operation region with a state after the switching may be expressed as the second operation region. Thus, the first operation region may be switched to the second operation region in response to the first touch operation.

in step 304: in response to a second touch operation acting on the second operation region, a target game object identifier is determined from the at least one first game object identifier;

In the embodiment of the present disclosure, the first operation region before the switching may be for the selection of different signal types, which may be expressed as determining the target signal identifier from the at least one signal identifier, while the second operation region may be for the selection of different specific game objects, which may be expressed as determining the target game object identifier from the at least one first game object, and that is, according to the respective touch operations for the first operation region and the second operation region, by providing the operation region including different selection object levels and by selecting different selection objects included in the different selection object levels, the selection of different signal types and the selection of specific game objects may be achieved.

In practical applications, in the process of providing the player with a quick selection of a specific game object (i.e. a target game object), the player may first be provided with the second operation region, and different game objects may be provided in the second operation region to allow the player to perform the selection, and that is, by means of a manner that the different game objects are provided and then the target game object is determined, a touch error caused by the sliding touch strength of the player may not occur, so as to further improve an exchange speed and an accuracy for sending the signal.

It should be noted that, the second operation region, obtained by switching after determining the target signal identifier selected by the first touch operation, may be for the selected current signal type, i.e., the operation region of the target signal identifier, and the different game objects included in it belong to the current signal type.

in step 305: in response to an end of the second touch operation, a target signal for the target game object identifier is sent according to the target signal identifier.

In an embodiment of the present disclosure, the player may perform the touch operation on the second operation region corresponding to the current signal type, i.e., the selected target signal identifier. The second operation region may include a plurality of first game object identifier corresponding to different game objects, after detecting that the second touch operation of the player acting on any game object identifier determines the target game object, if it is detected that the player ends the second touch operation acted on, the target signal may be sent according to the target game object corresponding to the target game object identifier selected by the player, where the type of the target signal for the target game object is determined by the selected target signal identifier.

As an example, at least one of the selected signal identifiers provided in the first operation region may include “attack”, “retreat”, and the like. If the “retreat” signal identifier is selected, the second operation region obtained by switching may include a game object, usually a teammate or a location, associated with the “retreat” signal identifier, and after detecting a selection operation of the player for a teammate in the second operation region, i.e., the touch operation for the first game object identifier corresponding to the teammate, the target signal of “xxx retreat” may be sent.

In the embodiment of the present disclosure, the first operation region with signal identifiers corresponding to different signal types is provided in response to the interaction operation acting on the graphical user interface, the target signal identifier is determined in response to the first touch operation acting on the first operation region, then the target game object identifier is determined in response to the second touch operation acting on the second operation region provided by the user according to the target signal identifier, and after the second touch operation response ends, the target signal for the game object corresponding to the target game object identifier is sent according to the target identifier. By providing the sending method with corresponding operation regions under different states, the player may quickly select different signal types and specific game objects, so as to improve the exchange speed and the accuracy for sending the signal and avoid the accidental touch caused by too dense prompt objects in the mini map.

In order to facilitate those skilled in the art to further understand the sending method with corresponding operation regions under different states provided in the embodiments of the present disclosure, regions provided by the graphical user interface are described as follows:

In the embodiment of the present disclosure, the player may quickly select different signal types and specific game objects through a sending method with double-ring form and corresponding operation regions under different states. In a preferred embodiment, while the operation region is provided, the display region corresponding to the operation region may also be provided, which is used for displaying an identifier that is touchable in the operation region and displaying touch results of the player.

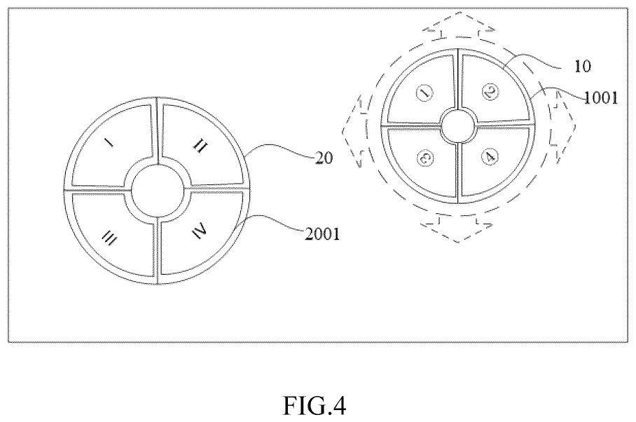

Specifically, referring to FIG. 4, a schematic diagram of a display region and an operation region in the embodiment of the present disclosure is shown. After responding to the interaction operation of the graphical user interface, the called-out preset interface may provide the player with the operation region 10 and the display region 20 in a double-ring shape. The display region and the operation region provided may have two states, and levels of the selection object operated and displayed in the display region and the operation region under the two states are different.

The operation region and the display region provided have a data link relationship of corresponding operation-view, which may be shown as the state of the display region is consistent with the state of the operation region, and no matter under what state, levels of the selection object provided by the display region and the operation region are the same, and a number of display sub-regions included in the display region is the same as a number of operation sub-regions included in the operation region, both the display region and the operation region are provided with an inner ring and an outer ring in shape, and the display region is identified according to the operation region.

The operation region may include a first operation region in a first state (i.e. an inner-ring state) and a second operation region in a second state (i.e. an outer-ring state), and the display region may include a first display region under the inner-ring state and a second display region under an outer-ring state corresponding to the operation region.

In an optional embodiment, the provided operation region 10 may include an operation sub-region 1001, and each operation sub-region may correspond to each identifier. Thus, the selection of the target identifier may be determined by the touch operation performed on the target operation sub-region where the target identifier is located. In practical applications, as shown in FIG. 4, under the inner-ring state, the operation region 10 at a left region may be the first operation region, the display region 20 in a right region may be the first display region, and the first operation region 10 may have a first operation sub-region 1001 for selecting at least one signal identifier, such as \textcircled{1}, \textcircled{2}, \textcircled{3}, \textcircled{4}, which may correspond to signal identifiers, such as I, II, III and IV, provided by a first display sub-region 2001 in the first display region 20.

After switching the inner-ring state to the outer-ring state, that is, after switching the first operation region to the second operation region, in FIG. 4, the operation region 10 in the left region may be the second operation region after switching, the display region 20 in the right region may be the second display region, and the second operation region 10 may have the second operation sub-region 1001 for selecting at least one first game object identifier, such as \textcircled{1}, \textcircled{2}, \textcircled{3} \textcircled{4}, which may correspond to the first game object identifier provided by the first display sub-region 2001 in the second display region 20, such as I, II, III and IV.

It should be noted that the provided second operation region may be obtained by switching from the first operation region in essence, and the second display region may also be obtained by switching from the first display region, and that is, interface layouts provided by the graphical user interface may be the same before and after that switching, except that the provided interface provides different selection objects for the user before and after that switching, which is not limited in the embodiments of the present disclosure. In order to achieve the operation-view corresponding relationship, the display region may be identified according to the operation region, which may be expressed as, when a touch operation acting on any one of the first operation sub-region and/or the second operation sub-region is detected, identifying the first display sub-region and/or the second display sub-region corresponding to the first operation sub-region and/or the second operation sub-region that is/are touched.

In the embodiment of the present disclosure, the player may quickly select different signal types and specific game objects by providing the sending method with the double-ring form and corresponding operation regions under different states, so as to improve the exchange speed and the accuracy for sending the signal and avoid the accidental touch caused by too dense prompt objects in the mini map. In addition, the provided operation region is also provided with a corresponding display region, using the sending method with the double-ring form, a hot zone trigger of the operation region is linked with the visual effect of the display region in real time to achieve the operation-view corresponding relationship, so as to provide an intuitive touch result for the player

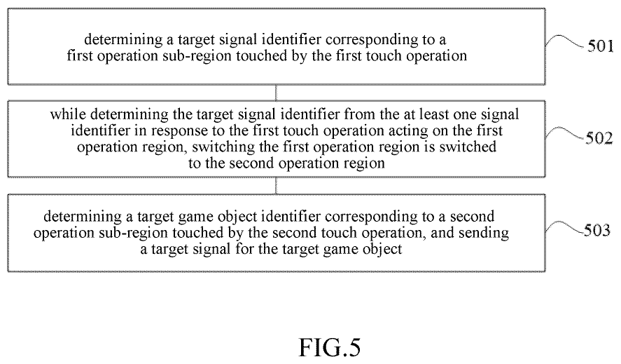

Referring to FIG. 5, a step flowchart of another method for processing a game signal of the embodiment of the present disclosure is shown. A graphical user interface is provided through the terminal, which may specifically include the following steps:

in step 501, a target signal identifier corresponding to the first operation sub-region touched by the first touch operation is determined;

In an embodiment of the present disclosure, it may be that in response to the interaction operation (such as a click operation) acting on the graphical interface, the signal roulette wheel of different signals for the player to select is called out. The signal roulette wheel may include the first operation region and the first display region having a corresponding relationship. When the signal roulette wheel turns to different positions, different signal identifier may be selected accordingly. That is, the signal roulette wheel is called out first, and afterwards, the prompt objects with different signal identifiers may be selected in the operation region, such that the touch error caused by the sliding touch strength of the player does not occur

It should be noted that the specific form of the called-out preset interface may also be the form other than the signal roulette wheel, which is not limited in the embodiments of the present disclosure.

In response to the first touch operation acting on the first operation region, the first operation sub-region touched may be determined, and a corresponding signal identifier may be determined by the first operation sub-region touched as the target signal identifier. In a preferred embodiment, an initial signal may also be sent according to the determined target signal identifier.

The first operation region may be for the selection of different signal types. When the touch operation acting on the first operation region is detected, the currently selected signal type (i.e. the target signal identifier) may be determined, and the initial signal may be sent according to this signal type. It should be noted that there is no specific sending/receiving object for the initial signal sent. When the first operation region is switched, the initial signal may be a signal generated on the signal roulette wheel, and that is, a second operation region for the current signal type is provided.

In practical applications, it may be expressed that the player may select any one of the first operation sub-regions. When the player releases his hand, he may send a fuzzy signal (that is, the initial signal). The fuzzy signal may be enemy disappearance, a warning, a go and a gathering, and the like, which is not directional, and that is, the teammate is not able to tell where to gather, who to attack, where to disappear and who needs to retreat. As an example, when the signal type “go” is selected in the first operation sub-region, a fuzzy signal of being on the way may be sent, which may merely include information of sending the signal, without including specific information of the specific game object “going to”, so as to meet a game requirement for quick sending.

It should be noted that timing for sending the initial signal may be after the target signal identifier is determined from the at least one signal identifier in response to the first touch operation acting on the first operation region, and whether or not there is a subsequent second touch operation detected on the second operation region, the initial signal for the target signal identifier may be sent.

in step 502, while the target signal identifier is determined from the at least one signal identifier in response to the first touch operation acting on the first operation region, the first operation region is switched to the second operation region.

In the specific implementation, the first operation region may include a plurality of first operation sub-regions for different signal identifiers. The first operation sub-region may be provided with a visual region for displaying to the player and a hot zone for providing the player with touches on different operation sub-regions. The first touch operation may be expressed not only as an sliding operation on any one of the first operation sub-regions after clicking the signal icon to call out the signal roulette wheel, but also as a subsequent sliding operation after performing the initial sliding operation on any one of the first operation sub-regions.

The performed sliding operation may be expressed as a selection for a certain signal type and the sending of the initial signal for the current signal type, and the performed subsequent sliding operation may be expressed as a selection intention for a specific game object under the current signal type.

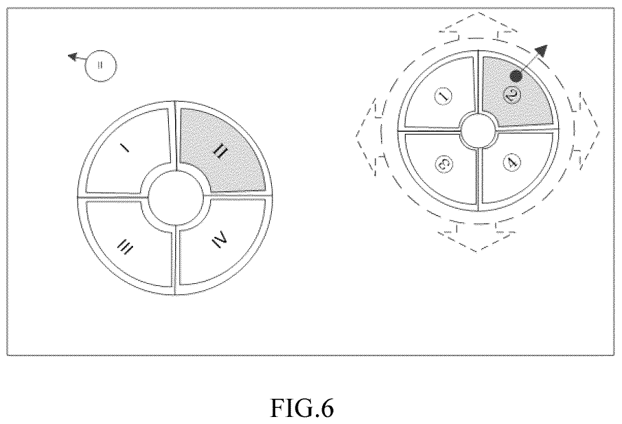

Specifically, as shown in FIG. 6, the player may slide outward on the first operation sub-region, such as a region where \textcircled{2} is located, and when the performed sliding operation touches outwardly an outer-ring hot zone (such as a virtual region in FIG. 6), a state of the current signal roulette wheel may be switched, and that is, the first operation sub-region under the first state is switched to the second operation sub-region under the second state, so as to provide different game objects belonging to the current signal type the player for selection.

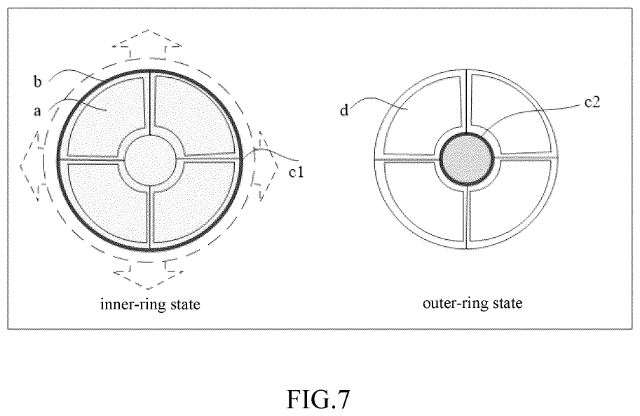

In a preferred embodiment, referring to FIG. 7, a specific schematic diagram of an operation region under different states in the embodiment of the present disclosure is shown. The first operation region under the inner-ring state may include a first inner-ring region with a first inner-ring hot zone and a first outer-ring region with a first outer-ring hot zone divided based on a boundary c1 (which may refer to a boundary of a first hot zone) of a hot zone. The first inner-ring region under the inner-ring state may refer to a region of a shaded part in FIG. 7, and the first outer-ring region may refer to a region other than the shaded part in FIG. 7, i.e. a dashed region.

In an embodiment of the present disclosure, the first touch operation may be a first sliding operation from the first inner-ring hot zone to the first outer-ring hot zone, and that is, when the sliding operation of the player acting on an operation sub-region of a certain signal identifier is detected to contact an outer-ring region outside the boundary c1 of the hot zone under the inner-ring state as shown in FIG. 7, proceeding to the outer-ring state, and switching the first operation region to the second operation region. The aforementioned sliding operation, i.e., an operation of the first sliding operation from the first inner-ring hot zone to the first outer-ring hot zone, is continuous.

A timing for switching the first operation region to the second operation region may be at the same time that the target signal identifier is determined from the at least one signal identifier in response to the first touch operation acting on the first operation region. Specifically, the first operation region may be switched to the second operation region including the at least one first game object identifier.

in step 503, a target game object identifier corresponding to the second operation sub-region touched by the second touch operation is determined, and a target signal for the target game object is sent.

After the switching, the second operation region corresponding to the target signal identifier and the second display region having the corresponding relationship may be displayed, where the first game object identifier of the target signal identifier may be acquired and the second display region with the first game object identifier may be displayed. That is, by calling out the operation region for selecting different first game objects, and then selecting the target game object, the touch error caused by the sliding touch strength of the player does not occur.

In an embodiment of the present disclosure, under the second state (i.e. after entering the outer-ring state), the second operation sub-region touched may be determined in response to the second touch operation acting on the second operation region, and then the corresponding first game object identifier may be determined through the second operation sub-region touched as the target game object identifier. Moreover, when the end of the second touch operation is detected, the target signal of the target game object corresponding to the target game object identifier may be sent according to the target signal identifier.

As shown in FIG. 7, the second operation region under the outer-ring state may include a second inner-ring region with a second inner-ring hot zone and a second outer-ring region with a second outer-ring hot zone divided based on a boundary c2 (which may refer to a boundary of a second hot zone) of a hot zone. The second touch operation may be expressed as a second sliding operation acting on the second outer-ring hot zone, and that is, the player may slide outward on a second operation sub-region acting on a certain first game object identifier, and when an outer-ring hot zone (i.e., a region of a non-shaded part in FIG. 7) outside the boundary c2 of the hot zone is touched outwardly, the current target game object identifier may be determined. It should be noted that the aforementioned sliding operation, i.e., an operation of the second sliding operation acting on the second outer-ring hot zone, is continuous.

In a preferred embodiment, under the outer-ring state, an area of the inner-ring hot zone (i.e., the region of the shaded part in FIG. 7) divided by the boundary c2 of the hot zone is greatly reduced compared with that under the inner-ring state, while an area of the outer-ring hot zone (i.e., the region of the non-shaded part in FIG. 7) for touch is increased compared with that under the inner-ring state.

Specifically, the game scene may include at least one virtual character, the virtual character may be a game virtual character controlled by a player through a mobile terminal, and may be presented through a graphical user interface. The presented content may include all of the virtual character or a part of the virtual character. For example, in a third-person game, the content presented by the graphical user interface may include all of the virtual character; or, in a first-person game, the content presented by the graphical user interface may include a part or local of the virtual character. In addition, the game scene may also include at least one virtual object, and the virtual object may be a game virtual character controlled by an enemy player in the game, or a non-practicing character (NPC) preset by the game developer in a specific game scene.

In this example, as shown in FIG. 6, a given signal indication may be determined according to a distance and a position of the nearby game object, and the target signal sent may be an orientation signal of the target game object. It should be noted that the sent orientation signal may change in real time according to the different game objects selected.

As shown in FIG. 6, it may be assumed that under the first state, the signal identifier II displayed in the first display sub-region of the first display region is an orientation signal identifier, the first operation sub-region \textcircled{2} in the first operation region corresponds to the signal identifier II, if the player performs the first sliding operation on the first operation sub-region, an interface under the first state may be switched to the second state, and the first operation region and the first display region is switched to the second operation region and the second display region, respectively. The second operation region after the switching is used to determine the target game object, I, II, III and IV displayed in the second display region may refer to different game object identifiers, respectively, it is assumed that the player performs the second sliding operation on the second operation sub-region \textcircled{2}, the game object identifier II corresponding to the second operation sub-region \textcircled{2} may be used as the target game object, and when the end of the second sliding operation is detected, the orientation signal of the game object identifier II shown in FIG. 6 may be sent.

It should be noted that the first game object identifier displayed in the display sub-region may be a game object that the virtual character is within a field of view and a game object that does not appear on the map.

In a first case, when it is detected that a game object corresponding to the second operation sub-region acted on is a game object that the virtual character is within a field of view, a signal may be sent in a manner that it is directly displayed on a screen of the player, for example, the signal is sent directly on the screen, which sends an attack signal to attack a specific game object of the enemy.

In a second case, when it is detected that a game object corresponding to the second operation sub-region acted on is a game object that does not appear on the map, in order not to affect the fairness of both sides in a competitive game, at this time, the signal sent is different from the directly displayed orientation signal mentioned above, and the signal may be sent in a manner of sending a sound signal of “attack xxx (the game object is not displayed on the map)”, or in a manner of text broadcasting a signal of “attack xxx (the game object is not displayed on the map)”. For example, the signal is directly sent on the screen, including a mini map, an identifier on the virtual character, a banner broadcast and a voice, but any display information containing position information of the object will be blocked.

It should be noted that when a dead game object is displayed in the display sub-region with the first game object identifier, a mark for indicating death may be added, and the player cannot select the dead game object.

In the embodiment of the present disclosure, the above method for processing the game signal may also be applied to the following scenarios:

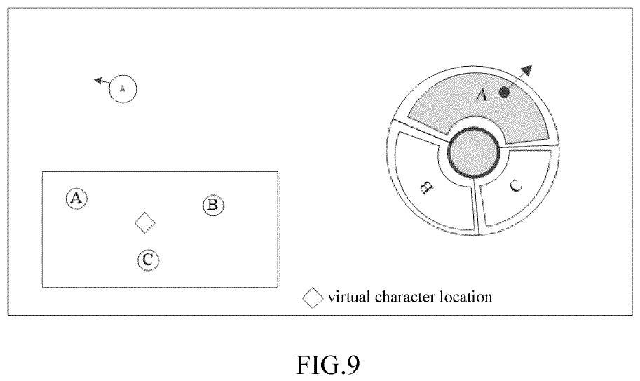

Referring to FIG. 9, an application scenario diagram of a method for processing a game signal in an embodiment of the present disclosure is shown. When there are a plurality of game objects, assuming that they are enemy characters, which may be, for example, A, B, C, the second operation region may be used to provide the player with a selection of different prompt objects. Specifically, corresponding prompt objects for selection may be provided, and as an example, the prompt object may be an identifier indicating an attack on a certain enemy hero, that is, a plurality of second operation sub-regions for selecting a hero identifier, such as the hero identifier A, B, C, are provided, so as to select the above prompt objects according to an orientation of the enemy character in real time, without opening the mini map to view the orientation of the enemy character.

A position of an enemy character identifier, such as A, B, C, may be updated according to real-time orientation information of the virtual character, and that is, the position of the enemy character identifier may move with a real-time movement of the virtual character.

In an embodiment of the present disclosure, content displayed on the graphical user interface includes a virtual character and a plurality of game objects. when the first operation region is switched to the second operation region, in addition to the above that the second operation region may be generated according to the selected target signal identifier, the second operation region including the at least one first game object identifier may also be generated according to the first orientation information of the virtual character and multiple pieces of second orientation information corresponding to the plurality of game objects, so as to switch the first operation region to the second operation region.

The virtual character may refer to a game virtual character controlled by the player through a mobile terminal, while a plurality of game objects may refer to a plurality of enemy characters, and the first game object identifier may refer to an identifier corresponding to the plurality of enemy characters and located in the display region.

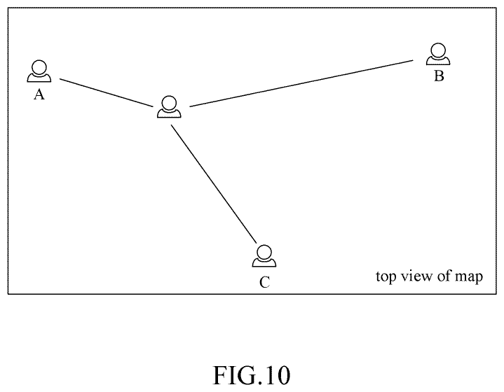

The second operation region including the at least one first game object identifier is generated. Specifically, a top view map of the game scene may be acquired, as shown in FIG. 10. The top view map may is provided with the virtual character identifier and at least one second game object identifier, such as A, B, C; in the top view map, multiple pieces of distance information between the virtual character identifier and the second game object identifier may be determined according to the first orientation information and the multiple pieces of second orientation information; then, a plurality of game objects whose distance information meets a preset condition may be determined, and the second operation region may be generated according to the first game object identifier corresponding to the game objects whose distance information meet the preset condition. The second game object identifier refers to an enemy character identifier located in the map, and thus, according to the distance between the enemy character identifier and the virtual character identifier, the enemy character identifier meeting the condition (i.e., the second game object identifier) may be used as the first game object identifier for generating the second operation region, and the determined first game object identifier may be displayed in the display region.

In the embodiment of the present disclosure, after the first operation region is switched to the second operation region generated according to the orientation information, an orientation identifier of a game object corresponding to the target game object identifier may also be displayed, such that the player may select the prompt object according to an orientation of the enemy character in real time.

In the process of displaying the orientation identifier of the game object, a position relationship between the virtual character identifier and the game object corresponding to the target game object identifier may be determined, and the orientation identifier for the target game object identifier is displayed according to the position relationship.

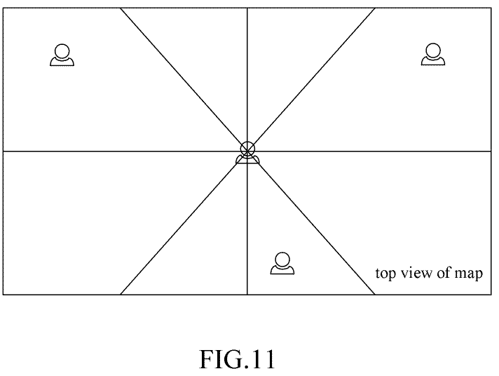

Specifically, the position relationship of the target game object with respect to the virtual character may be determined according to a target quadrant region. Referring to FIG. 11, a schematic diagram of a divided quadrant regions in an embodiment of the present disclosure is shown.

In practical applications, the steps to determine the position relationship between the virtual character and the game object corresponding to the target game object identifier may include that: a top view map of the game scene may be acquired; where the top view map is provided with a plurality of quadrant regions divided with a virtual character identifier as a center; a target quadrant region where the target game object identifier is located may be determined, and a position relationship of the game object corresponding to the target game object identifier with respect to the virtual character is determined according to the target quadrant region.

Different game objects may appear in different quadrant regions, the orientation may be given according to the quadrant region where the selected target game object is located, and the orientation is displayed on the screen of the player. For example, if a certain target game object is located on an upper left corner of the divided quadrants, as shown in FIG. 9, a specific direction of the target game object, such as A, may be given on the screen of the player

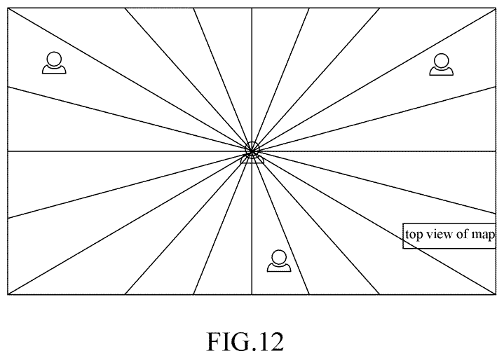

It should be noted that, as shown in FIG. 12, the plurality of quadrant regions obtained by dividing may be obtained by dividing and combining a plurality of quadrants, then when the more quadrants are divided, the position of the determined target game object may be more accurate, i.e., when a number of quadrants reaches a sufficient number, the real-time change of the position of the selected target game object may be achieved.

In a preferred embodiment, in the process of displaying the determined first game object in the display region, a gradient identifier of the game object may also be displayed in the display region (which may be referred to as the second display region) for the game object corresponding to the second game object with the smallest distance from the virtual character identifier according to the multiple pieces of distance information, where the gradient identifier is set to identify game object with the closest distance. Specifically, according to a linear distance from different game objects in the top view of the map, and according to the linear distance, the game object is displayed in the corresponding second display region under the outer-ring state, so as to provide the player with a quick selection. It should be noted that the presentation thereof displayed in the second display region may be in a form of gradient, flicker, and the like, which is not limited in the embodiments of the present disclosure.

In practical applications, the closest game object may also be judged by the linear distance obtained above, as shown in FIG. 10. Specifically, it may be expressed as determining the game object with the smallest linear distance, and adding the gradient identifier to its corresponding displayed second display sub-region.

As an example, assuming there are game objects A, B and C, and quadrant distances between the virtual character and the above game objects may be x, y and z, respectively (where x<z<y), all of the A, B and C may be displayed in the second display sub-region, and a special halo is added to the second display sub-region displayed by the game object A visually, for identifying the game object A as the closest game object.

In the embodiment of the present disclosure, the inner-ring region and the outer-ring region in the operation region divided based on the boundary of the hot zone are described as follows:

In an optional embodiment, as shown in FIG. 7, the operation region under both the inner-ring state and the outer-ring state includes the inner-ring region and the outer-ring region, and the inner-ring region and the outer-ring region may be divided by the boundary of the hot zone. The inner-ring region under the inner-ring state may refer to a region of a shaded part in FIG. 7, and the outer-ring region may refer to a region other than the shaded part in FIG. 7, i.e. a dashed region. The inner-ring region under the outer-ring state may refer to a region of a shaded part in FIG. 7, and the outer-ring region may refer to a region of a non-shaded part in FIG. 7.

The first operation sub-region under the inner-ring state may be provided with a first inner-ring hot zone a and a first visual region b, and the second operation sub-region under the outer-ring state may be provided with a second outer-ring hot zone d. When the selection object is selected, an inner-ring sub-hot zone of the selection region (which may refer to each operation sub-region) may be slightly smaller than an inner-ring sub-region, to avoid the situation of selecting two hot zones at the same time. Moreover, in the second outer-ring region under the outer-ring state, an outer-ring hot zone thereof may be extended in a fan shape. Specifically, when the target game object is determined, the hot zone for touch may be extended in a fan shape to a very large region, such that when it is slid to a further region, the player may still select the specific game object in the fan-shaped region and not cancel the sliding state.

In a preferred embodiment, the boundary of the hot zone may not only be a boundary for dividing the inner-ring region and the outer-ring region, but it may also be a boundary for different state transitions.

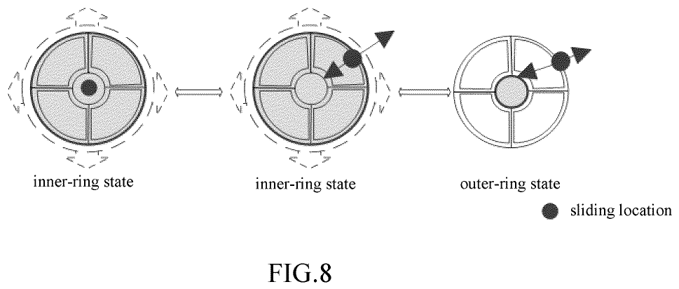

The specific process of the inner and outer-ring state is shown in FIG. 8. Under the inner-ring state, the player may start sliding for the region of the shaded part (i.e. the inner-ring hot zone) divided by the boundary of the hot zone, when sliding along an arrow shown in FIG. 8 in a direction from a bottom left to a top right, and touching the outer-ring region (i.e. the outer-ring hot zone of the dashed region in the drawing) outside the boundary divided by the boundary of the hot zone, the player may then switch from the inner-ring state to the outer-ring state, i.e., perform the outer-ring state, such that the player may select specific game objects under the current signal type. Meanwhile, under the outer-ring state, when sliding along an arrow shown in FIG. 8 in a direction from the top right to the bottom left and touching the inner-ring region (i.e. a region of a shaded part in FIG. 8, which is the inner-ring hot zone) within the boundary divided by the boundary of the hot zone, the player may switch from the outer-ring state to the inner-ring state, i.e. exit the outer-ring state, such that the player may achieve the subsequent selection of other signal types provided under the inner-ring state. It should be noted that the player may release the above sliding operation acted on.

In an optional embodiment, under the inner-ring state, the boundary of its hot zone may be expanded as much as possible to avoid the misoperation of the player to an outer circle; while under the outer-ring state, the boundary of its hot zone may be reduced a lot to leave enough space for the player to select the specific game object and avoid the misoperation.

Specifically, the boundary of the first hot zone and the boundary of the second hot zone have different ranges; where a range of the boundary c1 of the first hot zone is larger than a preset first range, and a range of the boundary c2 of the second hot zone is smaller than a preset second range. It should be noted that values of the preset first range and the preset second range may be game experience values, which is not limited in the present disclosure.

In the embodiment of the present disclosure, the hot zone is determined and changed by the boundary of the hot zone in the operation zone, so as to achieve the transition of the inner and outer-ring and the object selection. In addition, the sending method with double-ring form is adopted for the player to quickly select different signal types and specific objects, improve the interactive speed and the accuracy for sending the signal, without worrying about the too dense prompt objects in the mini map. For one's own virtual character and different game objects, the quadrant method may be used to determine the real-time position of the target game object, and the linear distance is used to determine the closest game object, so as to achieve a real-time position signal prompt of the target game object and the signal prompt of the nearby game object, and help the player make decisions quickly. In addition, through the real-time data link between the hot zone trigger of the operation region and the visual effect of the display region, the operation-view corresponding relationship is formed, so as to achieve the real-time change and the signal prompt based on the operation region and the display region, and improve the operation experience and efficiency.

It should be noted that, for the sake of simple description, the method embodiments are described as a series of action combinations, but those skilled in the art should aware that the embodiments of the present disclosure are not limited by the described action sequences, since according to the embodiments of the present disclosure, certain steps may be performed in other sequences or simultaneously. In addition, those skilled in the art should also aware that the embodiments described in the specification are all preferred embodiments, and the actions involved are not necessarily required by the embodiments of the present disclosure.

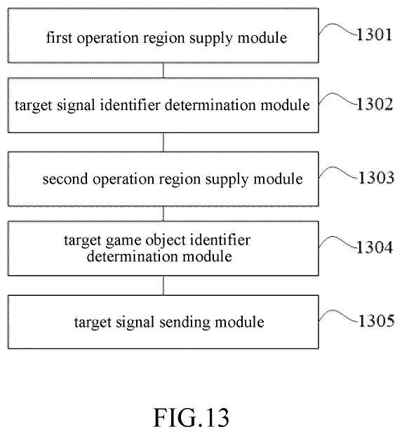

Referring to FIG. 13, a structure block diagram of an apparatus for processing a game signal according to an embodiment of the present disclosure is shown. A graphical user interface is provided through a terminal, which may specifically include the following modules:
a first operation region supply module 1301, configured to provide, in response to an interaction operation acting on the graphical user interface, a first operation region, where the first operation region includes at least one signal identifier; a target signal identifier determination module 1302, configured to determine, in response to a first touch operation acting on the first operation region, a target signal identifier from the at least one signal identifier;
a second operation region supply module 1303, configured to provide a second operation region and at least one first game object identifier through the graphical user interface;
a target game object identifier determination module 1304, configured to determine, in response to a second touch operation acting on the second operation region, a target game object identifier from the at least one first game object identifier;
a target signal sending module 1305, configured to send, in response to an end of the second touch operation, a target signal for the target game object identifier according to the target signal identifier. In an embodiment of the present disclosure, the first operation region includes an inner-ring hot zone and a first outer-ring hot zone divided based on a boundary of a hot zone; the second operation region includes a second outer-ring hot zone

In an embodiment of the present disclosure, the second operation region supply module 1303 may include the following sub-modules:
a second operation region supply sub-module, configured to switch while determining the target signal identifier from the at least one signal identifier in response to the first touch operation acting on the first operation region, the first operation region to the second operation region.

In an embodiment of the present disclosure, the first touch operation is a first sliding operation from the inner-ring hot zone to the first outer-ring hot zone; the at least one first game object identifier is located in the second operation region; and the second operation region supply sub-module may include the following units:

a second operation region supply unit, configured to switch the first operation region to a second operation region including the at least one first game object identifier.

In an embodiment of the present disclosure, after the determining, in response to the first touch operation acting on the first operation region, the target signal identifier from the at least one signal identifier, the apparatus may also include the following modules:

an initial signal sending module configured to send, if the second touch operation is not detected, an initial signal for the target signal identifier.

In an embodiment of the present disclosure, the second touch operation is a second sliding operation acting on the second outer-ring hot zone. The target game object identifier determination module 1304 may include the following sub-modules:

a target game object identifier determination sub-module configured to determine, in response to the second sliding operation acting on the second outer-ring hot zone, a corresponding first game object identifier of the second outer-ring hot zone selected by sliding as the target game object identifier.

In an embodiment of the present disclosure, content displayed on the graphical user interface includes a virtual character and a plurality of game objects; the second operation region supply sub-module may include the following units:

a second operation region generation unit configured to generate, according to first orientation information of the virtual character and multiple pieces of second orientation information corresponding to the plurality of game objects, a second operation region including the at least one first game object identifier, and switch the first operation region to the second operation region.

In an embodiment of the present disclosure, the content displayed on the graphical user interface includes at least a part of a game scene; the second operation region generation unit may include the following sub-units:
a top view map acquisition sub-unit, configured to acquire a top view map of the game scene, where the top view map is provided with a virtual character identifier and at least one second game object identifier;
a distance information determination sub-unit, configured to determine, according to the first orientation information and the multiple pieces of second orientation information, multiple pieces of distance information between the virtual character identifier and the second game object identifier in the top view map;
a second operation region generation sub-unit, configured to determine a plurality of game objects whose distance information meet a preset condition, and generate, according to the first game object identifier corresponding to the game objects whose distance information meet the preset condition, the second operation region.

In an embodiment of the present disclosure, the second operation region supply module 1303 may include the following sub-modules:

a first game object identifier supply sub-module, configured that the graphical user interface provides a display region while providing an operation region, where the at least one first game object identifier is located in the display region.

In an embodiment of the present disclosure, content displayed on the graphical user interface further includes at least a part of a game scene; the second operation region supply module 1303 may also include the following sub-modules:
a top view map acquisition sub-module, configured to acquire a top view map of the game scene, where the top view map is provided with a virtual character identifier and at least one second game object identifier;
The distance information determination sub-module, configured to determine according to the first orientation information and multiple pieces of second orientation information, multiple pieces of distance information between the virtual character identifier and the second game object identifier in the top view map;
According to the multiple pieces of distance information, for a game object corresponding to the second game object identifier with the smallest distance from the virtual character, a gradient identifier of the game object is displayed in the display region, where the gradient identifier is configured to identify a game object with a closest distance.

In an embodiment of the present disclosure, after switching the first operation region to the second operation region, the second operation region supply module 1303 may also include the following sub-modules:

an orientation identifier display sub-module, configured to display an orientation identifier of a game object corresponding to the target game object identifier.

In an embodiment of the present disclosure, the orientation identifier display sub-module may include the following units:

an orientation identifier display unit, configured to determine a position relationship between the virtual character and the game object corresponding to the target game object identifier, and display the orientation identifier for the target game object identifier according to the position relationship.

In an embodiment of the present disclosure, the content displayed on the graphical user interface further includes at least a part of a game scene; the orientation identifier display unit may include the following sub-units:
a top view map acquisition sub-unit, configured to acquire a top view map of the game scene; where the top view map is provided with a plurality of quadrant regions divided with a virtual character identifier as a center;
a position relationship determination sub-unit, configured to determine a target quadrant region where the target game object identifier is located, and determine a position relationship between the game object corresponding to the target game object identifier and the virtual character according to the target quadrant region.

As for the apparatus embodiments, since basically similar to the method embodiments, the description is relatively simple, and reference may be made to the partial description of the method embodiments for related parts.

The embodiments of the present disclosure further provide an electronic device, including:
a processor, a memory, and a computer program stored on the memory and executable by the processor, when the computer program is executed by the processor, various processes of the above embodiments of the method for processing the game signal are implemented, and the same technical effect is achieved, in order to avoid repetition, which is not repeated herein.

The embodiments of the present disclosure also provides a computer-readable storage medium with a computer program stored thereon, when the computer program is executed by a processor, various processes of the above embodiments of the method for processing the game signal are implemented, and the same technical effect is achieved, in order to avoid repetition, which is not repeated herein.

The embodiments in this specification are described in a progressive manner, each embodiment focuses on the differences from other embodiments, and the same and similar parts between the various embodiments may be referred to each other.

It should be understood by those skilled in the art that the embodiments the present disclosure may be provided as a method, an apparatus, or a computer program product. Accordingly, embodiments of the present disclosure may take the form of an entirely hardware embodiment, an entirely software embodiment, or an embodiment combining software and hardware aspects. Furthermore, embodiments of the present disclosure may take the form of a computer program product implemented on one or more computer-usable storage medium (including, but not limited to, disk storage, CD-ROM, optical storage, etc.) containing computer-usable program code.

Embodiments of the present disclosure are described with reference to flowcharts and/or block diagrams of methods, terminal devices (systems), and computer program products according to embodiments of the present disclosure. It will be understood that each process and/or block in the flowcharts and/or block diagrams, and combinations of processes and/or blocks in the flowcharts and/or block diagrams, can be implemented by computer program instructions. These computer program instructions may be provided to the processor of a general purpose computer, special purpose computer, embedded processor or other programmable data processing terminal device to produce a machine that causes the instructions to be executed by the processor of the computer or other programmable data processing terminal device to generate means for implementing the functions specified in a process or processes of the flowcharts and/or a block or blocks of the block diagrams.

These computer program instructions may also be stored in a computer readable memory capable of directing a computer or other programmable data processing terminal device to operate in a particular manner, such that the instructions stored in the computer readable memory generate an article of manufacture including instruction means. The instruction means implement the functions specified in a process or processes of the flowcharts and/or a block or blocks of the block diagrams.

These computer program instructions can also be loaded on a computer or other programmable data processing terminal device, so that a series of operational steps are performed on the computer or other programmable terminal device to produce a computer-implemented process, thereby the instructions executed on the computer or other programmable terminal device provide steps for implementing the functions specified in a process or processes of the flowcharts and/or a block or blocks of the block diagrams.

While preferred embodiments of the embodiments of the present disclosure have been described, additional changes and modifications to these embodiments may be made by those skilled in the art once the basic inventive concepts are known. Therefore, the appended claims are intended to be construed to include the preferred embodiment as well as all changes and modifications that fall within the scope of the embodiments of the present disclosure.

Finally, it should also be noted that in this document, relational terms such as first and second are used to distinguish one entity or operation from another, and do not necessarily require or imply that there is any such actual relationship or sequence between these entities or operations. Moreover, the terms “comprising”, “including” or any other variation are intended to encompass non-exclusive inclusion such that a process, method, article or terminal device that includes a list of elements includes not only those elements, but also other elements not explicitly listed, or also include elements inherent to such a process, method, article or terminal device. Without further limitation, an element defined by the phrase “comprises a . . . ” does not preclude the presence of additional identical elements in the process, method, article, or terminal device that includes the element.

A method and apparatus for processing a game signal provided by the present disclosure have been described above in detail. Specific examples herein are used to illustrate the principles and implementations of the present disclosure. The above description of the embodiments is used to help understand the method and core concepts of the present disclosure. Meanwhile, for those skilled in the art, according to the concept of the present disclosure, there will be changes in specific embodiments and application scope. As mentioned above, the contents of this specification should not be construed as limiting the present disclosure.

1. A method for processing a game signal, comprising:
in response to an interaction operation acting on a graphical user interface provided by a terminal, providing, by the terminal, a first operation region, wherein the first operation region comprises at least one signal identifier;
in response to a first touch operation acting on the first operation region, determining, by the terminal, a target signal identifier from the at least one signal identifier;
providing, by the terminal, a second operation region and at least one first game object identifier through the graphical user interface;
in response to a second touch operation acting on the second operation region, determining a target game object identifier from the at least one first game object identifier; and
in response to an end of the second touch operation, sending a target signal for the target game object identifier according to the target signal identifier.

2. The method according to claim 1, wherein the first operation region comprises an inner-ring hot zone and a first outer-ring hot zone, and the inner-ring hot zone and the first outer-ring hot zone are divided based on a boundary of a hot zone; and the second operation region comprises a second outer-ring hot zone.

3. The method according to claim 2, wherein providing the second operation region through the graphical user interface comprises:
switching, in response to the first touch operation acting on the first operation region, the first operation region to the second operation region.

4. The method according to claim 3, wherein the first touch operation is a first sliding operation from the inner-ring hot zone to the first outer-ring hot zone; the at least one first game object identifier is located in the second operation region; wherein the switching the first operation region to the second operation region comprises:
switching the first operation region to a second operation region comprising the at least one first game object identifier.

5. The method according to claim 1, further comprising:
in response to determining the second touch operation is not detected, sending an initial signal for the target signal identifier.

6. The method according to claim 2, wherein the second touch operation is a second sliding operation acting on the second outer-ring hot zone, and wherein determining the target game object identifier from the at least one first game object identifier comprises:
determining, in response to the second sliding operation acting on the second outer-ring hot zone, a corresponding first game object identifier of the second outer-ring hot zone selected by sliding as the target game object identifier.

7. The method according to claim 4, wherein content displayed on the graphical user interface comprises a virtual character and a plurality of game objects; wherein switching the first operation region to the second operation region comprises:
generating, according to first orientation information of the virtual character and multiple pieces of second orientation information corresponding to the plurality of game objects, a second operation region comprising the at least one first game object identifier, and switching the first operation region to the second operation region.

8. The method according to claim 7, wherein the content displayed on the graphical user interface comprises at least a part of a game scene; wherein the generating, according to the first orientation information of the virtual character and the multiple pieces of second orientation information corresponding to the plurality of game objects, the second operation region comprising the at least one first game object identifier comprises:
acquiring a top view map of the game scene, wherein the top view map is provided with a virtual character identifier and at least one second game object identifier;
determining, according to the first orientation information and the multiple pieces of second orientation information, multiple pieces of distance information between the virtual character identifier and the at least one second game object identifier in the top view map; and
determining a plurality of game objects whose distance information meet a preset condition, and generating, according to the first game object identifier corresponding to the plurality of game objects whose distance information meet the preset condition, the second operation region.

9. The method according to claim 1, wherein providing the at least one first game object identifier through the graphical user interface comprises:
providing a display region the graphical user interface while providing the first operation region and the second operation region through the graphical user interface, wherein the at least one first game object identifier is located in the display region.

10. The method according to claim 9, wherein content displayed on the graphical user interface further comprises at least a part of a game scene; and the method further comprises:
acquiring a top view map of the game scene, wherein the top view map is provided with a virtual character identifier and at least one second game object identifier;
determining, according to the first orientation information and multiple pieces of second orientation information, multiple pieces of distance information between the virtual character identifier and the at least one second game object identifier in the top view map; and
displaying, according to the multiple pieces of distance information, for a game object corresponding to the second game object identifier with a smallest distance from the virtual character identifier, a gradient identifier of the game object in the display region, wherein the gradient identifier is configured to identify a game object with a closest distance.

11. The method according to claim 7, further comprising:
displaying an orientation identifier of a game object corresponding to the target game object identifier.

12. The method according to claim 11, wherein the displaying the orientation identifier of the game object corresponding to the target game object identifier comprises:
determining a position relationship between the virtual character and the game object corresponding to the target game object identifier, and displaying the orientation identifier of the game object corresponding to the target game object identifier according to the position relationship.

13. The method according to claim 12, wherein the content displayed on the graphical user interface further comprises at least a part of a game scene; and wherein determining the position relationship between the virtual character and the game object corresponding to the target game object identifier comprises:
acquiring a top view map of the game scene; wherein the top view map is provided with a plurality of quadrant regions divided with a virtual character identifier as a center; and
determining a target quadrant region where the target game object identifier is located, and determining a position relationship between the game object corresponding to the target game object identifier and the virtual character according to the target quadrant region.

14. (canceled)

15. An electronic device, comprising a processor, a memory and a computer program stored on the memory and capable of running on the processor, wherein when the computer program is executed by the processor, the processor is configured to:
in response to an interaction operation acting on a graphical user interface provided by the electronic device, provide a first operation region, wherein the first operation region comprises at least one signal identifier;
in response to a first touch operation acting on the first operation region, determine a target signal identifier from the at least one signal identifier;
provide a second operation region and at least one first game object identifier through the graphical user interface;
in response to a second touch operation acting on the second operation region, determine a target game object identifier from the at least one first game object identifier; and
in response to an end of the second touch operation, send a target signal for the target game object identifier according to the target signal identifier.

16. (canceled)

17. The electronic device according to claim 15, wherein the first operation region comprises an inner-ring hot zone and a first outer-ring hot zone, and the inner-ring hot zone and the first outer-ring hot zone are divided based on a boundary of a hot zone; and the second operation region comprises a second outer-ring hot zone.

18. The electronic device according to claim 17, wherein the processor is further configured to:
switch, in response to the first touch operation acting on the first operation region, the first operation region to the second operation region.

19. The electronic device according to claim 18, wherein the first touch operation is a first sliding operation from the inner-ring hot zone to the first outer-ring hot zone; the at least one first game object identifier is located in the second operation region, and the processor is further configured to:
switch the first operation region to a second operation region comprising the at least one first game object identifier.

20. The electronic device according to claim 15, wherein the processor is further configured to:
send, in response to determining the second touch operation is not detected, an initial signal for the target signal identifier.

21. The electronic device according to claim 17, wherein the second touch operation is a second sliding operation acting on the second outer-ring hot zone, and the processor is further configured to:
determine, in response to the second sliding operation acting on the second outer-ring hot zone, a corresponding first game object identifier of the second outer-ring hot zone selected by sliding as the target game object identifier.

22. A non-transitory computer-readable storage medium with a computer program stored thereon, wherein when the computer program is executed by a processor, the processor is configured to:
in response to an interaction operation acting on a graphical user interface provided by a terminal, provide a first operation region, wherein the first operation region comprises at least one signal identifier;
in response to a first touch operation acting on the first operation region, determine a target signal identifier from the at least one signal identifier;
provide a second operation region and at least one first game object identifier through the graphical user interface;
in response to a second touch operation acting on the second operation region, determine a target game object identifier from the at least one first game object identifier; and
in response to an end of the second touch operation, send a target signal for the target game object identifier according to the target signal identifier.
